(19) United States
(12) Patent Application Publication
(10) Pub. No.: US 2020/0098363 A1
(43) Pub. Date: Mar. 26, 2020

(54) ELECTRONIC DEVICE

(71) Applicant: Onkyo Corporation, Osaka (JP)

(72) Inventor: Yusuke KONDO, Osaka (JP)

(21) Appl. No.: 16/547,426

(22) Filed: Aug. 21, 2019

(30) Foreign Application Priority Data
Sep. 25, 2018 (JP) 2018-178611

(51) Int. Cl. G10L 15/22; G06F 3/16

(52) U.S. Cl. CPC G10L 15/22; H04W 4/80; G10L 2015/223; G06F 3/165

(57) ABSTRACT

An electronic device performing wireless communication with a device which includes a microphone and a speaker, wherein the electronic device sets the device to a second mode which performs music reproduction when the electronic device receives direction of the music reproduction based on voice input in a first mode which receives the voice input to the microphone.

### CROSS-REFERENCE TO RELATED APPLICATIONS

This application claims priority to Japanese Application No. 2018-178611, filed Sept. 25, 2018, the entire contents of which are incorporated herein by reference.

### FIELD

The present disclosure relates to an electronic device which performs voice recognition.

### BACKGROUND

A smart device (for example, a smart phone) is paired to a general Bluetooth (registered trademark) (hereinafter referred to as “BT”) headset and a BT speaker, music reproduction and telephone can be performed via BT. In US 2008/0300025 A1, in communication between a BT headset and a smart phone, the following is disclosed. At voice recognition, communication is performed with high data rate, and at voice communication, communication is performed with low date rate.

Each of profiles of BT is assigned to music reproduction and telephone. Profile of music reproduction is A2DP (Advanced Audio Distribution Profile) and profile of telephone is HFP (Hands Free Profile)/HSP (Headset Profile). At telephone, a microphone which is included in a BT device collects speaking of a wearer, and a speaker which is included in the BT device outputs voice of a person at on the other end of line. In a BT device which corresponds to these profiles, music reproduction and telephone can be performed.

An application of the smart device sets the smart device to BT telephone mode by selecting telephone profile. The application of the smart device includes AI (Artificial Intelligence) function, and by analyzing voice which is input from the microphone of the BT device, the application can answer to a question of a user from the speaker of the BT device, for example. Hereinafter, this is called AI mode. When the user speaks a voice trigger (for example, a keyword such as “Hi, Onkyo.”) in the AI mode, the smart device transits to AI operation that performs operation to answer to a question from the user, for example. In the AI mode, the microphone of the BT device always becomes a voice collecting state and electric power consumption is higher than a general waiting state because a voice trigger must be always received.

Further, when music is reproduced by telephone mode, sound quality is deteriorated because of the telephone mode which performs communication by HFP/HSP in the AI mode. When the user enjoys music, the user enjoys in music mode according to A2DP profile in general.

As described above, there are various problems in conventional technology.

### SUMMARY OF THE DISCLOSURE

According to one aspect of the disclosure, there is provided an electronic device performing wireless communication with a device which includes a microphone and a speaker, wherein the electronic device sets the device to a second mode which performs music reproduction when the electronic device receives direction of the music reproduction based on voice input in a first mode which receives the voice input to the microphone.

### BRIEF DESCRIPTION OF THE DRAWINGS

FIG. 1 is a block diagram illustrating a configuration of a smart phone and a headset according to an embodiment of the present disclosure.

FIG. 2 is a sequence diagram illustrating processing operation of the headset and the smart phone in AI mode.

FIG. 3 is a sequence diagram illustrating processing operation of the headset and the smart phone in music mode.

FIG. 4 is a sequence diagram illustrating processing operation of the headset and the smart phone in hybrid mode.

### DETAILED DESCRIPTION OF THE PREFERRED EMBODIMENTS

An objective of the present disclosure is to be able to reproduce music in good sound quality in a voice input waiting state.

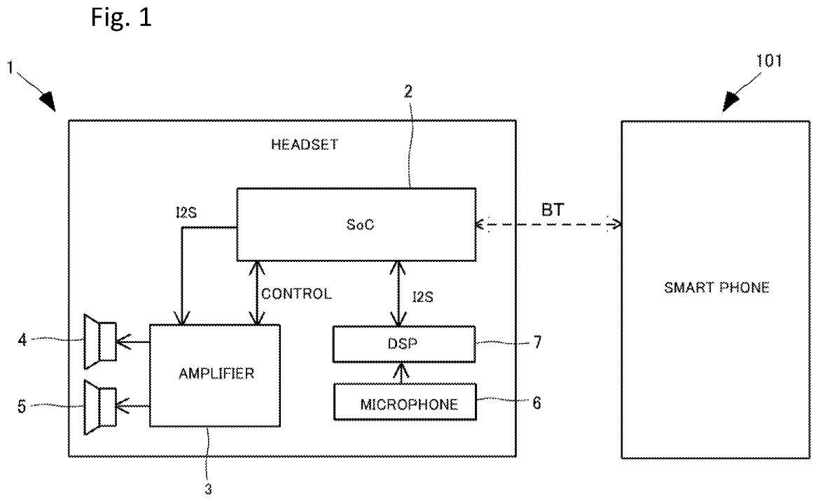

An embodiment of the present invention is described below. FIG. 1 is a block diagram illustrating a configuration of a smart phone and a headset according to an embodiment of the present invention. A headset 1 performs wireless communication with a smart phone 101 according to Bluetooth (registered trademark) (hereinafter referred to as “BT”.) standard. As illustrated in FIG. 1, the headset 1 (device) includes an SoC (System on Chip) 2, an amplifier 3, speakers 4 and 5, a microphone 6, a DSP (Digital Signal Processor) 7 and so on.

The SoC 2 (controller) has a CPU (Central Processing Unit), a DSP (Digital Signal Processor), a memory and so on, and controls each section composing the headset 1. Further, the SoC 2 includes a BT communication function and performs BT wireless communication with the smartphone 101. The SoC 2 receives an audio signal from the smart phone 101, for example. The SoC 2 outputs the audio signal which is received from the smart phone 101 to the amplifier 3.

The audio signal of I2S system is output to the amplifier 3 from the SoC 2. The amplifier 3 amplifies the audio signal and outputs the amplified audio signal to the speakers 4 and 5. An L channel audio signal is output to the speaker 4. An R channel audio signal is output to the speaker 5. The speakers 4 and 5 output audio to external based on the audio signal. Namely, the SoC 2 outputs audio from the speakers 4 and 5 by outputting the audio signal to the amplifier 3. In this manner, the headset 1 outputs audio based on the audio signal which is output from the smart phone 101.

The microphone 6 collects surrounding audio. The audio signal which is collected by the microphone 6 is output to the DSP 7. The DSP 7 performs noise cancel and echo cancel against the audio signal which is collected by the microphone 6. Further, the DSP 7 outputs the audio signal of I2S system to which noise cancel and echo cancel are performed to the SoC 2. The SoC 2 sends the audio signal to the smart phone 101.

The smart phone 101 (electronic device) includes an SoC (controller), a display, an operation section and so on, not shown. The SoC controls each section composing the smart phone 101. The display is an LCD (Liquid Crystal Display) which displays texts, still images, movies and so on. The operation section has a touch panel which is linked with a display and the other operation buttons.

The headset 1 and the smart phone 101 perform communication according to HFP/HSP or communication according to A2DP. Mode which performs communication according to HFP/HSP is called AI mode (first mode) since the mode is to receive voice input to the microphone 6 and follow directions and the like by voice input. The AI mode is also called call mode because the mode performs communication according to HFP/HSP. Mode of the headset 1 and the smart phone 101 which perform communication according to A2DP profile is called music mode (second mode) because the mode performs music reproduction. Further, mode which includes the AI mode and the music mode is called hybrid mode. The hybrid mode is described later. The SoC of the smart phone 101 controls mode of the headset 1 and the smart phone 101.

In the AI mode, the SoC 2 of the headset 1 sends the audio signal which is input to the microphone 6 to the smart phone 101. The SoC of the smart phone 101 receives the audio signal which is sent from the headset 1. The SoC of the smart phone 101 performs voice recognition base on the received audio signal. In the AI mode, after the user speaks a voice trigger (predetermined keyword) (for example, “Hi, Onkyo”) and the voice trigger is recognized, direction or the like by voice input is received. In the present embodiment, voice recognition is performed by the SoC of the smart phone 101. Not limited to this, the audio signal may be sent from the smart phone 101 to an external server, and the external server may perform voice recognition.

The user operates the smart phone 101 and can set to any mode. The SoC of the smart phone 101 receives selection of the AI mode, the musicmode or the hybridmode via the operation section. Herein, in the AI mode, electric power consumption is high because the microphone 6 is the voice input waiting state. In the music mode, electric power consumption is low because the microphone 6 is not the voice input waiting state.

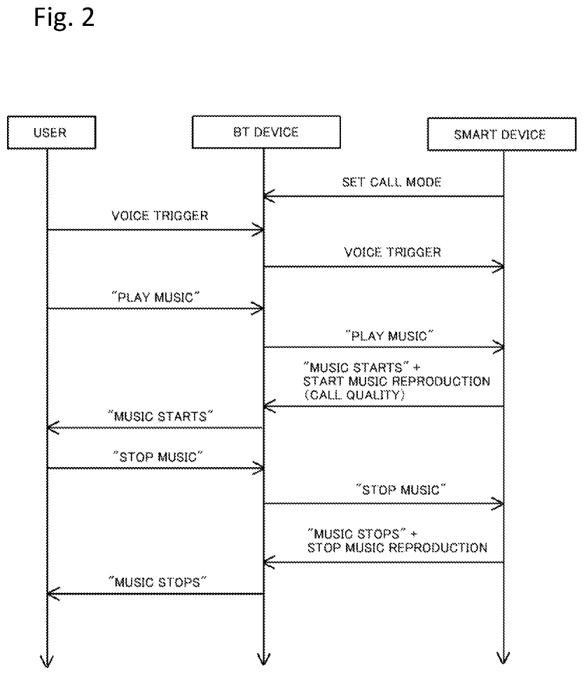

Processing operation of the headset 1 and the smart phone 101 in each mode is described below. In FIG. 2 to FIG. 4, the headset 1 is described as “BT device” and the smart phone 101 is described as “smart device”. FIG. 2 is a sequence diagram illustrating processing operation of the headset 1 and the smart phone 101 in the AI mode. When the SoC of the smart phone 101 receives selection of the AI mode, the SoC of the smart phone 101 sets the headset 1 to the call mode. The user speaks a voice trigger. The SoC 2 of the headset 1 sends the voice trigger which is collected by the microphone 6 to the smart phone 101.

The SoC of the smart phone 101 receives the voice trigger which is sent from the headset 1 and performs voice recognition of the received voice trigger. After the SoC recognizes the voice trigger and receives the voice trigger by voice input, the SoC receives the other voice input.

Next, the user speaks “Playmusic”. The SoC 2 of the headset 1 sends “Play music” which is collected by the microphone 6 to the smart phone 101. The SoC of the smart phone 101 receives “Play music” which is sent from the headset 1 and performs voice recognition. The SoC understands “Play music”, creates audio texts of “Music starts”, and sends them to the headset 1. At the same time, the SoC sends music to the headset 1 to start music reproduction. Herein, music reproduction is performed with call quality because the headset 1 and the smart phone 101 are in the AI mode (the call mode). The SoC 2 of the headset 1 receives audio texts of “Music starts” and outputs them from the speakers 4 and 5.

Next, the user speaks “Stop music”. The SoC 2 of the headset 1 sends “Stop music” which is collected by the microphone 6 to the smart phone 101. The SoC of the smart phone 101 receives “Stop music” which is sent from the headset 1 and performs voice recognition. The SoC understands “Stop music”, creates audio texts of “Music stops”, and sends them to the headset 1. At the same time, the SoC stops sending music to the headset 1. The SoC 2 of the headset 1 receives audio texts of “Music stops” and outputs them from the speakers 4 and 5.

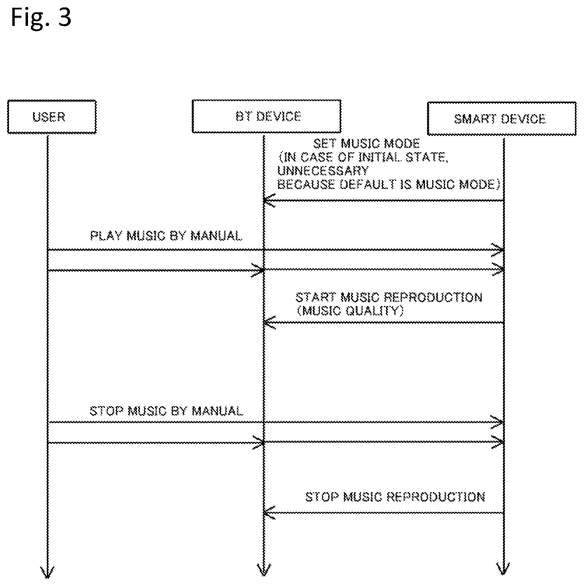

FIG. 3 is a sequence diagram illustrating processing operation of the headset 1 and the smart phone 101 in the music mode. In default, the headset 1 and the smart phone 101 are in the music mode. When the SoC of the smart phone 101 receives selection of the music mode from the other mode, the SoC sets the headset 1 to the music mode. As described above, in default, because of the music mode, in case of initial state, setting to the music mode is unnecessary. The user operates the smart phone 101 by manual, and makes the smart phone 101 reproduce music. The SoC sends music to the headset 1 to start music reproduction. Herein, music reproduction is performed with music quality because the headset 1 and the smart phone 101 are in the music mode.

Next, the user operates the smart phone 101 by manual, and makes the smart phone 101 stop music reproduction. The SoC stops sending music to the headset 1 to stop music reproduction.

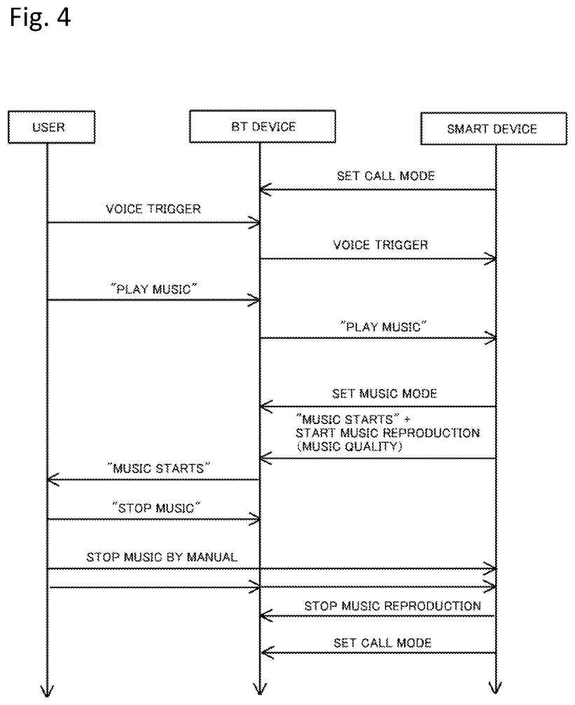

FIG. 4 is a sequence diagram illustrating processing operation of the headset 1 and the smart phone 101 in the hybrid mode. As described below, the hybridmode is a mode which switches the AI (call) mode and the music mode. When the SoC of the smart phone 101 receives selection of the hybrid mode, the SoC sets the headset 1 to the call mode. The user speaks a voice trigger. The SoC 2 of the headset 1 sends the voice trigger which is collected by the microphone 6 to the smart phone 101.

The SoC of the smart phone 101 receives the voice trigger which is sent from the headset 1 and performs voice recognition of the received voice trigger. After the SoC recognizes the voice trigger and receives the voice trigger by voice input, the SoC receives the other voice input.

Next, the user speaks “Playmusic”. The SoC 2 of the headset 1 sends “Play music” which is collected by the microphone 6 to the smart phone 101. The SoC of the smart phone 101 receives “Play music” which is sent from the headset 1 and performs voice recognition. The SoC understands “Play music” and sets the headset 1 to the music mode. Next, the SoC creates audio texts of “Music starts” and sends them to the headset 1. At the same time, the SoC sends music to the headset 1 to start music reproduction. Herein, music reproduction is performed with music quality because the headset 1 and the smart phone 101 are in the music mode. The SoC 2of the headset 1 receives audio texts of “Music starts” and outputs them from the speakers 4 and 5. In this manner, when the SoC is in the AI mode of the hybrid mode and receives direction of music reproduction based on voice input, the SoC sets the headset 1 to the music mode which performs music reproduction.

Next, the user speaks “Stop music”. Herein, voice input is not received because the headset 1 and the smart phone 101 are in the music mode. In other words, at the music mode, the SoC of the smart phone 101 does not receive voice input. Therefore, music reproduction does not stop. Next, the user operates the smart phone 101 by manual, and makes the smart phone 101 stop music reproduction. The SoC stops sending music to the headset 1 to stop music reproduction. Further, the SoC sets the headset 1 to the call mode. In other words, when the SoC receives direction of music reproduction stopping by other than voice input in the music mode of the hybrid mode, the SoC sets the headset 1 to the AI mode. At the AI mode which is not in the hybrid mode, even if the SoC receives direction of music reproduction based on voice input, the SoC does not set the headset 1 to the music mode.

As described above, in the present embodiment, when the SoC of the smart phone 101 receives direction of music reproduction based on voice input in the AI mode which receives voice input to the microphone 6 of the hybrid mode, the SoC sets the headset 1 to the music mode which performs music reproduction. Thus, music reproduction can be performed in good sound quality in a voice input waiting state. Further, in the existing headset 1, music reproduction and voice input (voice recognition) can be used in combination.

Further, in the present embodiment, the SoC of the smart phone 101 receives selection of the AI mode, the music mode, or the hybrid mode. Thus, the user can switch some modes based on its preference.

The embodiment of the present invention is described above, but the mode to which the present invention is applicable is not limited to the above embodiment and can be suitably varied without departing from the scope of the present invention.

In the above described embodiment, the headset is illustrated as the BT device. Not limited to this, the BT device may be a speaker with a microphone or the like.

The present invention can be suitably employed in an electronic device which performs voice recognition.

What is claimed is:

1. An electronic device performing wireless communication with a device which includes a microphone and a speaker,
wherein the electronic device sets the device to a second mode which performs music reproduction when the electronic device receives direction of the music reproduction based on voice input in a first mode which receives the voice input to the microphone.

2. The electronic device according to claim 1,
wherein the electronic device sets the device to the first mode when the electronic device is in a hybrid mode which includes the first mode and the second mode, and
the electronic device sets the device to the second mode when the electronic device receives direction of music reproduction based on the voice input in the first mode.

3. The electronic device according to claim 1,
wherein the electronic device does not receive the voice input to the microphone in the second mode.

4. The electronic device according to claim 1,
wherein the electronic device receives the other voice input after the electronic device receives a predetermined keyword by the voice input in the first mode.

5. The electronic device according to claim 2,
wherein the electronic device does not set the device to the second mode when the electronic device receives direction of music reproduction based on the voice input in the first mode which is not in the hybrid mode.

6. The electronic device according to claim 2,
wherein the electronic device sets the device to the first mode when the electronic device receives direction of music reproduction stopping by other than voice input in the second mode which is in the hybrid mode.

7. The electronic device according to claim 2,
wherein the electronic device receives selection of the first mode, the second mode, or the hybrid mode.

8. The electronic device according to claim 1,
Wherein the electronic device performs communication with the device according to HFP (Hands-Free Profile) or HSP (HeadSet Profile) in the first mode.

9. The electronic device according to claim 1,
wherein the electronic device performs communication with the device according to A2DP (AdvancedAudio Distribution Profile) in the second mode.

10. A control method of an electronic device performing wireless communication with a device which includes a microphone and a speaker,
wherein the device is set to a second mode which performs music reproduction when direction of the music reproduction is received based on voice input in a first mode which receives the voice input to the microphone.

11. A storage medium in which a control program is stored, the control program of an electronic device performing wireless communication with a device which includes a microphone and a speaker,
wherein the device is set to a second mode which performs music reproduction when direction of the music reproduction is received based on voice input in a first mode which receives the voice input to the microphone.
